(19) United States
(12) Patent Application Publication
(10) Pub. No.: US 2012/0273506 A1
(43) Pub. Date: Nov. 1, 2012

(54) Coated Insulated Coolers and Method of Manufacture

(76) Inventors: Martin Adams, Clewiston, FL (US); Eric Adams, Clewiston, FL (US)

(21) Appl. No.: 13/455,178

(22) Filed: Apr. 25, 2012

Related U.S. Application Data
(60) Provisional application No. 61/479,697, filed on Apr. 27, 2011.

(51) Int. Cl. B65D 81/38; B29C 65/00; B23P 15/26

(52) U.S. Cl. 220/592.25; 29/890.035; 156/60

(57) ABSTRACT

Disclosed is an improvement to temporary foam cooler box construction, wherein the foam cooler box is provided hardware inlays for cooler hardware and then treated with a polyurethane shell coating to improve the cooler box durability and carrying capacity over its bare foam counterpart. The inlays are backing hardware that are adhered directly to the foam and then coated with the polyurethane, whereafter cooler hardware such as latches and hinges may be fastened to the inlays and be supported by the inlays and the shell coating of the cooler. The present invention discloses both a new device and method of manufacture therefor.

### CROSS REFERENCE TO RELATED APPLICATION

This application claims the benefit of U.S. Provisional Application No. 61/479,697 filed on Apr. 27, 2011, entitled “AA Quality Custom Coolers.”

### BACKGROUND OF THE INVENTION

1. Field of the Invention

The present invention relates to insulated foam cooler boxes and temporary cooler boxes. More specifically, the present invention relates to a coating method and new structure for foam coolers that improves their durability, strength and carrying capacity over exposed foam coolers.

Foam cooler boxes are inexpensive alternatives to permanent or long-term use coolers, wherein the foam cooler boxes are generally available at convenience stores for temporary housing of food stuffs and ice for the purposes of keeping the contents of the cooler insulated for a period of time. These cooler boxes are generally inexpensive and consist of a foam molding having an interior volume for contents and a removable lid. The bare foam construction is useful for insulation purposes, but does not provide a high degree of durability, load carrying a capacity or strength with regard to lifting large loads and preventing failure of the cooler sidewalls. These coolers further provide little to no hardware in the way of lid hinges, closure brackets or the like. The lids of cooler boxes of this type are generally press-fit onto the upper rim of the cooler box, wherein no means of securing the lid is provided.

While these types of cooler boxes are convenient for last minute storage of food products or other important articles requiring refrigeration, they provide little in the way of durability for multiple uses, prolonged use or for harsher treatment. These cooler boxes are generally severely damaged after their use, to the point they are discarded and replaced when necessary. This leads to wasted material, environmental concerns and increased cost to the consumer. The present invention is provided for improving the strength and durability of such cooler boxes without changing its low price point. It is desired to disclose a cooler box and method of manufacture that incorporates foam cooler boxes, while improving their strength by coating the cooler box foam material with a polyurethane shell material, and further providing cooler box hardware mounting points for which to secure lid hinges, latches and other hardware that may serve useful during the deployment of the cooler box.

2. Description of the Prior Art

Several devices have been disclosed in the prior art that relate to the present invention. These include devices that have been patented or those that have been published in patent application documents. These devices have familiar design elements for the purposes of providing a rugged or reinforced cooler; however these devices fail to contemplate the present invention and its method of improving durability of existing foam cooler boxes in the market. The devices deemed most relevant to the present disclosure are herein described for the purposes of differentiating the present invention.

Specifically, U.S. Pat. No. 5,418,028 to DeWitt is one such device that discloses a cooler wall panel having a polymer core and a thermosetting polymer skin adhered directly to the core. The polymer skin comprises a polyisocyanurate type polymer coating of at least 30 mils thickness and the coating is coated with an aliphatic polyisocyanurate coating, which provides a structural skin for the polymer core material forming a wall structure of a larger walk-in type cooler having tongue-and-groove construction. Typically these cooler walls have aluminum or metallic backing structures that make their assembly difficult and their construction overly expensive. The DeWitt disclosure replaces the metallic backing structure with a polymer coating that improves structural integrity, improves assembly fitment and reduces overall costs. While the DeWitt disclosure involves a polymer core insulating cooler having an outer coating for strength, the DeWitt disclosure is directed to larger, walk-in coolers of the type found in convenience stores, rather than temporary and ad-hoc cooler boxes of the present invention. The present invention pertains to an improved construction of a handheld cooler box, which provides an outer shell coating to improve durability, load capacity and allows for the fitment of hardware latches thereto that were otherwise inhibited by the bare foam construction. The present invention is not interested in reducing the cost of a more complex walk-in cooler, but providing a new construction for an already inexpensive cooler box of the type generally used for outdoor events, parties and sporting events for keeping items cool.

Another device is U.S. Pat. No. 3,640,938 to Finelli that describes a polyurethane reaction mixture and method of making a laminate such that a polystyrene material can be coated to improve resistance to solvents, scuffing, chipping and tearing when deployed. The Finelli device discloses several examples and claims a mixture of polyurethane comprising of a prepolymer and a curative solution that forms a rubbery coating that does not react with polystyrene foam when applied. While this device and method is related to laminates of polyurethane and a foam material, it is more related to the chemical composition of the shell material than the construction of a cooler box and method of manufacture. It is desired to disclose an improved cooler box and method of making the cooler boxes using a polyurethane spray to form a shell over to the foam box, while also including hardware inlays for both improving the durability of the cooler box and adding hardware that is supported by the shell and foam of the box to improve the box usefulness and utility when deployed. While examples of working polyurethane spray solutions are disclosed, it is not desired to limit the present invention to a specific polyurethane spray chemical composition.

The present invention provides a means to improve the impact resistance, dent and chip resistance, load capacity and overall strength and durability of a foam cooler box, wherein the box is sprayed with a polyurethane spray to form a protective shell therearound. A plurality of hardware inlays provide backing structure and mounting hardware for latches, hinges and other cooler box hardware that is added to the foam cooler to improve its utility when in use, wherein the base foam cooler box lid is merely positioned on the upper lip of the box otherwise. It is submitted that the present invention is substantially diverges in design elements from the prior art, and consequently it is clear that there is a need in the art for an improved foam cooler box device. In this regard the instant invention substantially fulfills these needs.

### SUMMARY OF THE INVENTION

In view of the foregoing disadvantages inherent in the known types of foam cooler box now present in the prior art, the present invention provides a new foam cooler box device and method of manufacture wherein the same can be utilized for providing convenience for the user when utilizing an inexpensive cooler box having a hardened outer shell and a plurality of cooler box hardware attachments.

It is therefore an object of the present invention to provide a new and improved foam cooler box device and method of manufacture that has all of the advantages of the prior art and none of the disadvantages.

It is another object of the present invention to provide a cooler box having a polyurethane outer coating that is adapted to improve durability, dent resistance, overall strength of the cooler and load carrying capacity.

Another object of the present invention is to disclose a new method of manufacturing temporary or inexpensive foam cooler boxes that includes coating the bare foam with an outer polyurethane shell coating, and further applying attachment hardware for applying latches, hinges and other cooler hardware to the cooler.

Another object of the present invention is to provide a cooler box having improved construction and one that retains the relatively low cost of temporary foam coolers of the type purchased at convenient stores and grocery stores.

Yet another object of the present invention is to provide a cooler box having an outer shell polyurethane shell spray having a composition that has been shown to be effective at coating foam or polystyrene, as well as the mounting hardware applied to the foam prior to the application of the shell spray.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead perspective view of a typical shell-coated foam cooler box of the present invention, wherein the cooler box foam material is coated with a polyurethane and a plurality of hinges are applied to the lid for improved closure and handling thereof.

FIG. 2 shows a cross section view of a sidewall of a typical shell-coated foam cooler box of the present invention, wherein the sidewalls are coated in a uniform thickness shell of polyurethane material.

### DETAILED DESCRIPTION OF THE INVENTION

Reference is made herein to the attached drawings. Like reference numerals are used throughout the drawings to depict like or similar elements of the polyurethane shell-coated foam cooler box. For the purposes of presenting a brief and clear description of the present invention, the preferred embodiment will be discussed as used for providing a low cost cooler box having increased durability, and further disclosing a method of manufacture therefor. The figures are intended for representative purposes only and should not be considered to be limiting in any respect.

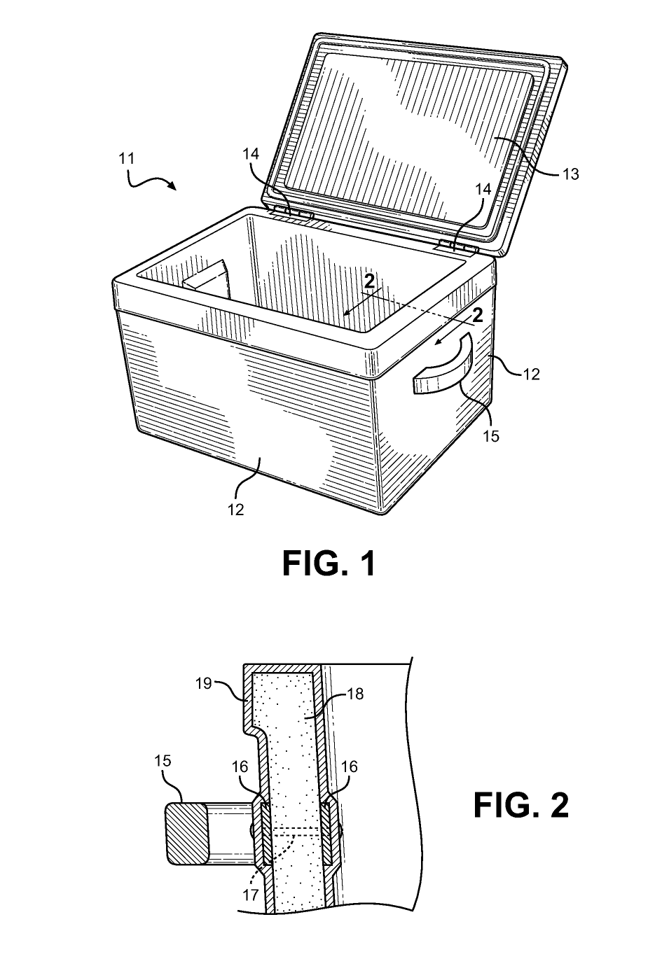

Referring now to FIG. 1, there is shown a perspective view of a cooler box construction of the present invention. The cooler box 11 comprises a Styrofoam or polystyrene structure having an interior volume, upstanding sidewalls 12 and a lid 13 that are formed of two unitary structures of homogeneous construction. The present invention contemplates improving the durability and strength of such temporary cooler boxes by providing a polyurethane spray shell that coats the foam walls of the cooler and forms a laminate of foam and shell material. The shell improves dent resistance, improves panel membraning and shearing, which improves overall structural strength and stability of the cooler, while also improving load carrying capacity and resistance to tearing or chipping. The bare foam is sprayed with a uniform thickness layer of thermoset coating that forms a protective barrier around the foam. Prior to being sprayed, a hardware inlays are adhered directly to the foam to form backing structure for later-applied cooler hardware, which may include lid hinges 14, latches for securing the lid, a through-hole in the manner of a drainage plug, handles 15, or any other assembly that may be added to the structure of the cooler to improve its utility when deployed. The inlays are backplates that form support for the hardware that are fastened thereinto after being sprayed. The spray is applied to the cooler and over the inlays after being adhered.

Traditional foam containers and cooler boxes are convenient and cheaper than more complex and sophisticated plastic and heavy-duty containers; however, they are not readily reusable, useable in a harsh environment or durable enough to withstand prolonged usage. The foam structure of the cooler can be easily dented or cracked, can breakdown over time, and is not resistant to chemical exposure. Additionally, hardware, such as hinges, drains, handles 15, and latches, cannot be easily attached to these bare-foam containers since the foam does not provide adequate tensile, bearing and pull-through fastener strength to mount heavier or stronger hardware brackets and assemblies. The present invention provides an inexpensive foam cooler alternative that is formed of an outer coating that improves the cooler strength and durability, while also allowing the cooler to support ancillary hardware that facilitates improved functionality while in use, and those accessories that are commonplace on more sophisticated cooler box assemblies. The improved durability is a key factor for those looking for a low-cost cooler box for use in the commercial, industrial, medical, or food industry, as well as by outdoors people, hunters, campers, tailgaters, picnickers, and those who require an inexpensive, well-insulated, well protected, pre-formed container at an economical price.

Referring now to FIG. 2, there is shown a cross section view of the cooler box sidewall structure. The foam interior 19 provides thermal resistance and insulation for cooled or heated interior contents, while the outer shell layer 19 provides a hardened, strengthened layer that protects the structure of the cooler and the inner foam core. The present device is manufactured using a spray process, wherein a bare foam cooler box is coated with a layer of polyurethane spray. Backplates 16 or hardware inlays for hardware attachments are adhered directly to the foam 18, whereafter the foam 18 and backplates 16 are covered by the spray shell 19. The backplates 16 provide a structure through which mounting hardware such as fasteners 17 may be supported through the walls of the cooler box. Along with the structure of the present invention, the method of manufacturing the assembly through the spraying a polyurethane protective coating on foam or foam containers is disclosed.

The outer shell spray is a treatment of the cooler foam panels that makes these items more durable and able to withstand harsher treatment. The spray is a polyurethane protective coating, preferably comprising of a polymeric methylene diphenyl diisocyanate (MDI), diphenylmethane, diisocyanate, and a curative of ethylene glycol without any solvents. The spray must comprise of a hardening solution that does not react with the foam core, wherein the spray cannot erode the foam upon application. This spray combination has been shown to be effective for creating a durable outer shell that is well adapted for application onto Styrofoam, polystyrene and similar foam cooler boxes. The coating is also applied to the backing plates attached to the foam, which support hinges, latches, drains, structural framework, and attached handles that are later connected to the container. The coating itself is provided in a variety of colors to suit user preference, wherein the application of the spray is preferably on cooler boxes of the foam type, comprising pre-formed, fabricated foam structures.

The disclosed method of manufacture comprises acquiring or forming a cooler box structure having upstanding sidewalls, a base, an open interior volume and a removable lid made of an insulative material and preferably foam. Hardware backplates are adhered to the foam if any additional hardware is desired on the cooler structure, including backplates for latches, hinges, exterior handles, interior supports and support plates for drainage through-holes. A polyurethane liquid spray comprising of polymeric methylene diphenyl diisocyanate (MDI), diphenylmethane, diisocyanate, and a curative of ethylene glycol without any solvents is used to coat the bare foam cooler box and the attached backplates to form uniform outer layer. The coating of liquid spray is allowed to cure into a hardened shell, whereafter the cooler hardware can then be fastened through the backplates and the cooler is assembled into its final form. The structure of the cooler is now a laminate having an inner foam core and an outer shell layer for strength and durability, while the attached hardware increases the utility of the cooler by adding convenience features and hardware to attach accessories, handles and hinges to the cooler.

Overall, it is desired to disclose a new and inexpensive cooler box that has improved durability characteristics, while retaining its overall low cost and wide availability normally associated with foam cooler boxes of the type found in convenient stores and shopping markets. The outer shell improves the structural stability of the cooler, allowing more and heavier contents to be carried with reduced risk of rupture, tearing or chipping of the otherwise bare foam material. The process of manufacture involves an acquisition or forming process, a spray process and assembly process to form the final product. It is not desired to limit the present invention to use with only a specific cooler shape or in conjunction with a polyurethane spray of a specific composition. Rather, it is desired to disclose a reinforced and durable cooler box and method of construction that improves the art of inexpensive cooler boxes.

In light of the present disclosure and the aforementioned prior art devices, it is submitted that the instant invention is sufficiently differentiated from the prior art and has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A cooler box device, comprising:
a cooler structure having upstanding sidewalls, and a base forming an interior volume;
said structure comprised of a unitary formed structure of an insulative foam material;
said cooler structure further comprising a unitary lid adapted to enclose said interior volume and comprised of said foam material;
cooler hardware backplates adhered to said cooler;
said cooler structure and lid foam material and backplates coated with a polyurethane outer shell spray to form a cooler laminate having an outer and inner shell layer and an inner foam core.

2) The device of claim 1, wherein said polyurethane spray further comprises polymeric methylene diphenyl diisocyanate (MDI), diphenylmethane, diisocyanate, and a curative of ethylene glycol without any solvents.

3) The device of claim 1, wherein said hardware backplates provide backing structure to attach latches, hinges, handles and other cooler hardware thereto without directly fastening to said foam material.

4) A method of manufacturing cooler box devices, comprising the steps of:
acquiring or forming a cooler box structure having upstanding sidewalls, and a base forming an interior volume formed of insulative foam material;
acquiring or forming a cooler box lid adapted to enclose said interior volume and comprised of said foam material;
adhering backplates to said foam material in locations wherein later attached cooler hardware may be secured;
spraying said cooler box, lid and backplates with a polyurethane outer shell spray to form a cooler laminate having an outer and inner shell layer and an inner foam core.

5) The method of claim 4, further comprising the steps of:
attaching cooler hardware to said backplates, including latches, hinges, drains, and handles.

6) The method of claim 4, wherein said polyurethane spray further comprises polymeric methylene diphenyl diisocyanate (MDI), diphenylmethane, diisocyanate, and a curative of ethylene glycol without any solvents.
